(19) United States
(12) Patent Application Publication
(10) Pub. No.: US 2015/0039475 A1
(43) Pub. Date: Feb. 5, 2015

(54) POINT OF SALE SYSTEM AND METHOD FOR SAMPLING AND PURCHASING DIGITAL CONTENT

(71) Applicant: OverDrive, Inc., Cleveland, OH (US)

(72) Inventor: Jeffrey Sterling, Hudson, OH (US)

(21) Appl. No.: 14/449,254

(22) Filed: Aug. 1, 2014

Related U.S. Application Data
(60) Provisional application No. 61/861,509, filed on Aug. 2, 2013.

(51) Int. Cl. G06Q 30/06; G06F 17/30

(52) U.S. Cl. CPC G06Q 30/0625; G06F 17/30882
USPC 705/26.62

(57) ABSTRACT

A system for sampling and purchasing digital content includes at least one processor, at least one computer-readable tangible storage device, and program instructions stored on the at least one storage device for execution by the at least one processor. The program instructions include first program instructions configured to receive data indicative of a keyword. The program instructions further include second program instructions configured to identify digital media content associated with the keyword. The program instructions further include third program instructions configured to communicate data indicative of a hyperlink, wherein the hyperlink is configured to link to sample content associated with the digital media content. The program instructions further include fourth program instructions configured to receive payment confirmation. The program instructions further include fifth program instructions configured to communicate data indicative of instructions for accessing the digital media content.

### CROSS-REFERENCE TO RELATED APPLICATIONS

This application claims priority to U.S. Provisional Patent Application No. 61/861,509 filed on Aug. 2, 2013, which is incorporated by reference herein in its entirety.

### FIELD OF INVENTION

The present disclosure relates to the field of digital media. More particularly, the present disclosure relates to point of sale system and method for sampling and purchasing digital content.

### BACKGROUND

Digital content has become increasingly popular with the commercial success of portable digital devices such as, for example, smartphones, tablet computers, eReaders, personal digital assistants, laptop computers, and the like. Digital content includes, for example, electronic books, also referred to as eBooks; digitized music in file formats such as MP3, WAV, M4a, and MWA; digitized video in file formats such as MPEG, MJPEG, MWV, and quicktime; news content configured for viewing on mobile devices; and many others.

In one example, eBooks, are becoming a popular format that provide an alternative to reading a physical book. Therefore, eBooks have also become an alternative format for selling books to consumers. Because eBooks are digital, various features and benefits can be included in an eBook that may not be offered to a purchaser of a physical book. In addition, eBooks can be purchased and downloaded conveniently by consumers using a variety of devices, such as those listed above, as eBooks can be downloaded any time or location that is convenient for the consumer.

### SUMMARY

A system for sampling and purchasing digital content includes at least one processor, at least one computer-readable tangible storage device, and program instructions stored on the at least one storage device for execution by the at least one processor. The program instructions include first program instructions configured to receive data indicative of a keyword. The program instructions further include second program instructions configured to identify digital media content associated with the keyword. The program instructions further include third program instructions configured to communicate data indicative of a hyperlink, wherein the hyperlink is configured to link to sample content associated with the digital media content. The program instructions further include fourth program instructions configured to receive payment confirmation. The program instructions further include fifth program instructions configured to communicate data indicative of instructions for accessing the digital media content.

A method for sampling and purchasing digital content includes the step of a computer receiving from a mobile computing device data indicative of a keyword. The method further includes the step of the computer identifying digital media content associated with the keyword. The method further includes the step of the computer communicating to the mobile computing device data indicative of a hyperlink, wherein the hyperlink is configured to link to sample content associated with the digital media content. The method further includes the step of the computer receiving payment confirmation from the mobile computing device. The method further includes the step of the computer communicating to the mobile computing device data indicative of instructions for accessing the digital media content.

A computer program product for sampling and purchasing digital content includes at least one computer-readable tangible storage device and program instructions stored on the at least one storage device. The program instructions include first program instructions configured to receive data indicative of a keyword. The program instructions further include second program instructions configured to identify digital media content associated with the keyword. The program instructions further include third program instructions configured to communicate data indicative of a hyperlink, wherein the hyperlink is configured to link to sample content associated with the digital media content. The program instructions further include fourth program instructions configured to receive payment confirmation. The program instructions further include fifth program instructions configured to communicate data indicative of instructions for accessing the digital media content.

### BRIEF DESCRIPTION OF THE DRAWINGS

In the accompanying drawings, structures are illustrated that, together with the detailed description provided below, describe example embodiments of the claimed invention. Where appropriate, like elements are identified with the same or similar reference numerals. Elements shown as a single component may be replaced with multiple components. Elements shown as multiple components may be replaced with a single component. The drawings may not be to scale. The proportion of certain elements may be exaggerated for the purpose of illustration.

FIG. 1 illustrates an example user interface of a mobile application for use in a point of sale system for sampling and purchasing digital content.

FIG. 2 illustrates an example point of sale system for sampling and purchasing digital content.

FIGS. 3A-3C illustrate example user interfaces of a mobile application for use in a point of sale system for sampling and purchasing digital content.

FIG. 4 is illustrates an example point of sale system for sampling and purchasing digital content.

FIG. 5 is a flow chart illustrating an example method for sampling and purchasing digital content.

FIG. 6 is a flow chart illustrating an example method for sampling and purchasing digital content.

FIG. 7 is a block diagram of an example computing system for implementing an example point of sale system for sampling and purchasing digital content.

### DETAILED DESCRIPTION

The following includes definitions of selected terms employed herein. The definitions include various examples, forms, or both of components that fall within the scope of a term and that may be used for implementation. The examples are not intended to be limiting. Both singular and plural forms of terms may be within the definitions.

“Computing device,” as used herein, refers to a laptop computer, a desktop computer, a smartphone, a personal digital assistant, a cellular telephone, a tablet computer, an eReader, or the like.

“Computer-readable medium,” as used herein, refers to a medium that participates in directly or indirectly providing signals, instructions, or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory, and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, Phase Change Memory, and other media from which a computer, a processor, or other electronic device can read. Signals used to propagate instructions or other software over a network, like the Internet, can be considered a “computer-readable medium.”

“Logic,” as used herein, includes but is not limited to hardware, firmware, software, or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Software,” as used herein, includes but is not limited to, one or more computer or processor instructions that can be read, interpreted, compiled, or executed and that cause a computer, processor, or other electronic device to perform functions, actions, or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system, or other types of executable instructions. The form of software may depend, for example, on requirements of a desired application, the environment in which it runs, or the desires of a designer/programmer or the like. Computer-readable or executable instructions can be located in one logic or distributed between two or more communicating, co-operating, or parallel processing logics and, thus, can be loaded or executed in serial, parallel, massively parallel, and other manners. One form of software is an app, or an application that executes on a mobile computing device such as a mobile phone.

Suitable software for implementing the various components of the example systems and methods described herein may be produced using programming languages and tools like Haskell, Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

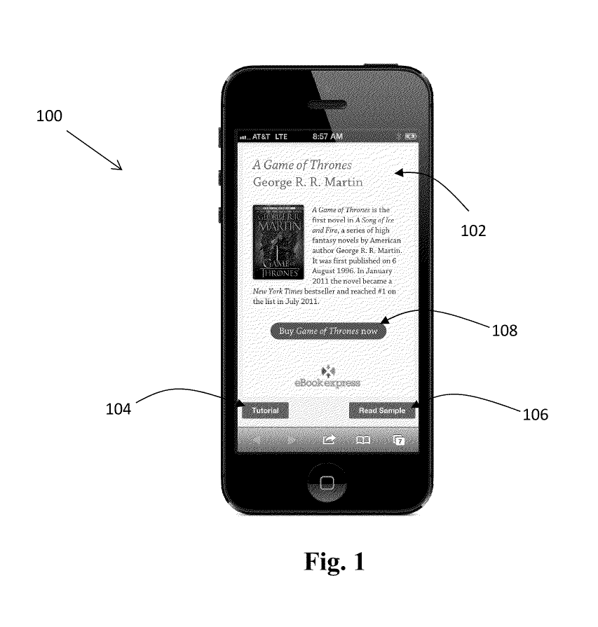

FIG. 1 illustrates an exemplary computing device for use with the systems and methods described herein. In FIG. 1, the computing device is illustrated as a mobile device 100, specifically a “smartphone.” However, it will be understood that computing devices for use with the systems and methods described herein are not limited to a smartphone or mobile computing device but include, for example, a kiosk, a laptop computer, a tablet computing device, an eReader, a personal digital assistant, a desktop computer, or any other similar device capable of communicating with a network.

The methods and systems described herein are arranged so that a user of the mobile device 100 can sample and purchase digital content via the mobile device 100. The mobile device 100 can include an application with a user interface 102 that enables a consumer to efficiently preview a sample of digital content and purchase the digital content directly from mobile device 100. As illustrated in FIG. 1, in one example, a consumer can sample and purchase digital content in the form of an eBook. Portions of the eBook can be displayed on the user interface 102 of the mobile device 100 such that a user of the mobile device 100 can review portions of the eBook and decide whether to purchase or rent the eBook. In FIG. 1, the digital content displayed on the user interface 102 includes the title and author of an eBook, a picture of the cover of the eBooks, and a short description of the eBook. It should be understood that, additional or different information about the eBook can be displayed, including but not limited to the price, reviews or other metadata about the eBook.

The user interface 102 can also include a number of buttons that provide functionality to the user of the mobile device 100. For example, the user interface 102 can include a tutorial button 104, a read sample button 106, and a buy it now button 108. The tutorial button 104 can be arranged to display instructions and explanations to the user of the mobile device 100 that guide the user through the features and functionality of the system for sampling and purchasing digital content. The read sample button 106 can be arranged to display a representative portion of the digital content for review by the user so that the user can better make purchasing decisions. The buy it now button 108 can be arranged to provide the user the ability to immediately purchase the digital content in full.

By providing systems and methods for efficiently sampling and/or purchasing digital content, a retailer is able to appeal to in-store retail customers that may not shop on the retailer's website but that may be interested in purchasing the retailer's digital content. For example, an in-store retail consumer can note that the retailer sells books and appreciate the ability to view a sample of the book in the consumer's preferred format—eBook format—prior to making a purchasing decision. In another example, an in-store consumer can appreciate the ability to select a physical book from a retailer's shelf, browse through the content of the book, and then purchase the book in the consumer's preferred eBook format. In addition, providing in-store consumers with a system for sampling and purchasing digital content may reduce a retailer's need to have every book it hopes to sell in its inventory of physical books. If in-store consumers have an alternative option, retailer can convert a portion of its inventory from physical books to eBooks while maintaining or even increasing sales.

It should be understood that, although certain descriptions and illustrations herein refer to digital content as eBooks, other suitable forms of digital content can be previewed and purchased through the systems and methods described herein. For example digital content in the form of audiobooks, newspaper articles, magazine articles, movies, music, and so on can similarly be sampled and purchased using the exemplary systems and methods described herein. In one example, a retailer can provide a select inventory of popular music in compact disc format, but may also provide a large and exhaustive catalog of popular music that can be sampled and purchased by in-store consumers via mobile device 100.

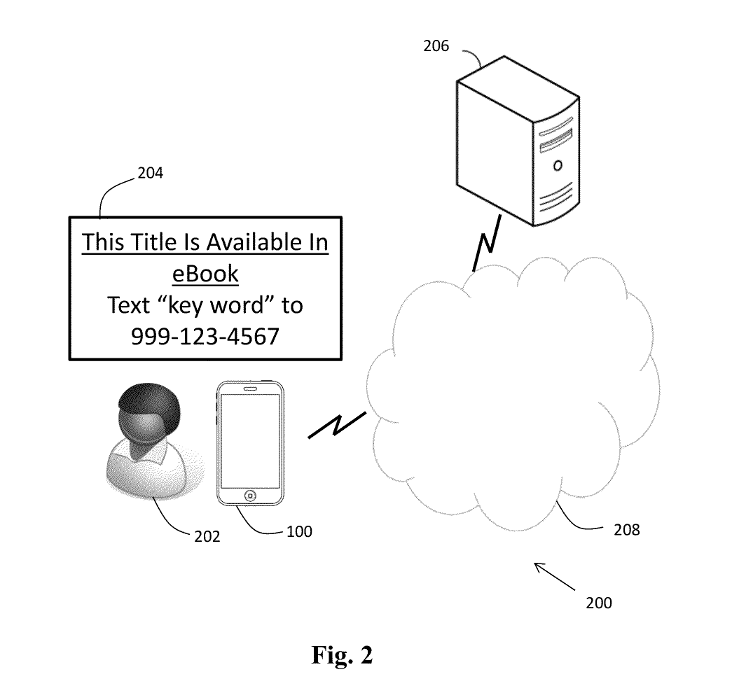

FIG. 2 illustrates an example system 200 for enabling a user 202 to sample and purchase digital content via mobile device 100. For example, a display 204 in a retail store can provides notification to user 202 that a particular title of a book is available for preview and for purchase as an eBook. In one example, the display 204 can be a sign located near the physical book shelves in a retail store. In the example of FIG. 2, display 204 provides user 202 with instructions to text a predefined keyword to a designated number in order to initiate an eBook preview and purchase process.

Each book can be associated with a predefined unique keyword or set of keywords. For example, a book titled “A Game of Thrones” may be associated with the keyword “game.” In one example, the entire title of the book may serve as the unique set of keywords for that book. A retail location can have multiple displays 204 positioned at or near multiple respective book titles. For example, a first display 204 instructing user 202 to text a first keyword in order to preview a first book can be positioned alongside a display of the physical first book while a second display (not shown) instructing user 202 to text a second keyword in order to preview a second book can be positioned alongside a display of the physical second book. In another example, a retail location may have a single display 204 that provides multiple keywords with multiple book titles. Display 204 can be a static display such as a cardboard sign or display 204 can be a configurable digital display. In another example, the display 204 can instruct a user 202 to visit a website accessible for the user's 202 mobile device 100 that lists a large or even exhaustive list of keywords that are associated with eBook titles. It will be understood that a website with such a large or exhaustive list can provide search functionality to allow the user 202 to quickly and efficiently find a keyword.

Mobile device 100 is configured to receive, via an input interface, a keyword from user 202. Mobile device 100 is further configured to communicate the keyword to a book server 206 via a network 208. In one example, the user 202 uses mobile device 100 to send a text message including the keyword to a designated telephone number, where a computer (not shown) at the receiving end of the designated telephone number is arranged to communicate the keyword to the book server 206 via the network 208. Network 208 may be the Internet, an intranet, a wireless or wired network, a cellular network, or any other suitable network, or any combination of networks.

Book server 206 is configured to identify an eBook title associated with a received keyword. For example, book server 206 can include a database of keywords associated with tiles of eBooks. Accordingly, book server 206 can search the database for the keyword in order to identify a title of an eBook.

Book server 206 is further configured to generate and communicate a hyperlink to mobile device 100 via network 208 based on the identified eBook. The hyperlink, when accessed or clicked on by user 202 via mobile device 100, directs a web browser on mobile device 100 to open and display a sample of the digital content of the identified eBook. In one example, the hyperlink can direct the web browser to a website that uses an online book reader application hosted by book server 206. In another example, the hyperlink can direct the web browser to a traditional mobile website that displays the eBook sample.

In one example, the hyperlink is a custom hyperlink unique to user 202. For example, based on the phone number from which a text message including the keyword is received by book server 206, book server is able to associate the request to a particular customer/mobile device. Thus, book server 206 can track purchase history associated with different customers based on phone numbers.

In one example, the hyperlink is a custom hyperlink unique to a store. In other words, book server 206 is configured to determine which store a user 202 is currently shopping at based on the request received. For example, each retail store may be provided with a different number for texting eBook preview requests to. In other words, a first store may have a display 204 that reads “Text key word to 999-123-4567” while a second store may have a display 204 that reads “Text key word to 888-987-6543.” Accordingly, book server 206 may be configured to determine which store a user 202 is currently shopping at based on the number through which the request was received.

In another example, the keyword associated with an eBook may vary between different stores. For example, book server 206 may associate keyword “bookX” with a particular eBook for a first store and may associate keyword “bookY” with the same eBook for a second store. Accordingly, book server 206 may be configured to determine which store a user 202 is currently shopping at based on the received keyword.

In yet another example, book server 206 may be configured to utilize geo-location data or other suitable data associated with a received request in order to determine which store a user 202 is currently shopping at. Thus, book server 206 may be configured to associate eBook purchases with a particular store. Such information can be used to credit the store for the sale, for example.

Book server 206 includes a sample algorithm that is configured to generate a sample of an eBook. In one example, the sample algorithm generates a sample consisting of a predefined percentage of the complete eBook such as 10%. For example, if an eBook is 100 pages long, sample algorithm generates a sample that is 10 pages long. In one example, sample algorithm is configured to skip over introductory content of the book, such as publisher information, the table of contents, etc. when generating the sample.

In one example, the sample algorithm is configured to execute one time during an administrative or setup process in which a new eBook is first introduced to system 200. The generated sample can be stored at book server 206 or in a database hosted by another server accessible to book server 206. The generated sample may then be accessed and provided to any user requesting to preview the eBook. In another example, the sample algorithm may generate a sample of an eBook in response to a request made to view a sample of the eBook for the first time. The same sample may then be used for subsequent requests to preview the same eBook.

In a third example, the sample algorithm may generate a new sample for each request made to preview an eBook. Accordingly, the sample generated may be customized for a specific user. For example, if a user's preference is to preview the table of contents, the sample algorithm may generate a sample that includes the table of contents for that specific user.

In one example, in response to user 202 clicking on the received hyperlink, mobile device 100 is configured to provide user interface 102, as described in FIG. 1, that gives user 202 an option of either previewing the eBook, via the read sample button 106, or purchasing the eBook, via the buy it now button 108. In addition, the user 202 can receive instructions and directions via the tutorial button 104.

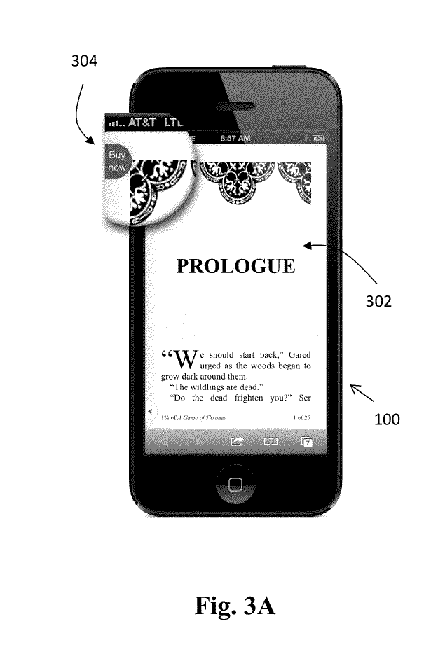

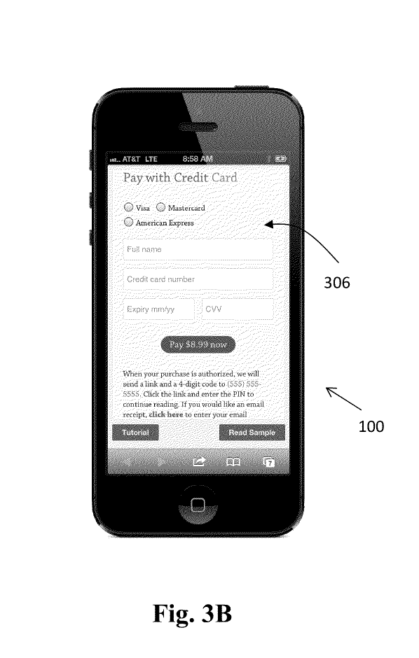

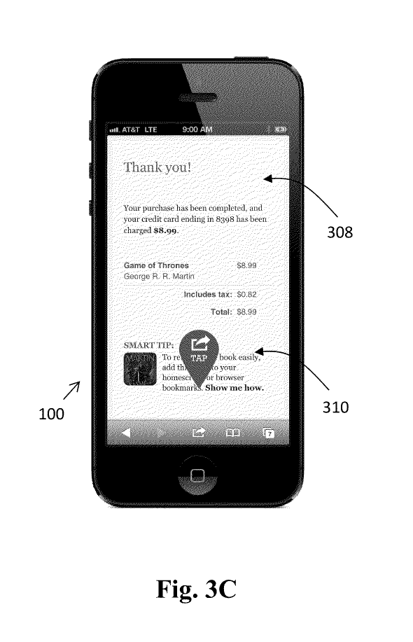

FIG. 3A illustrates an example user interface 302 of a mobile application that enables user 202 to preview the contents of an eBook in response to user 202 selecting the read sample button 106 or another similar button on interface 102. FIG. 3A illustrates the first page of an eBook. The user 202 can browse additional sample pages of the eBook by using navigational functions provided by any online book reader application provided with the sample of the eBook or navigational functionality native to the mobile device 100 if the sample of the eBook is provided to user 202 via a traditional mobile website. At any time while sampling the eBook, user 202 may click on or select a buy now button 304 on interface 302 in order to initiate the process for purchasing a complete version of the eBook being sampled.

FIG. 3B illustrates an example user interface 306 of a mobile application that enables user 202 to pay for an eBook. Mobile device 100 is configured to present user interface 306 to user 202 either after user 202 selects a purchase option via user interface 102 before previewing the eBook or after user 202 selects the Buy Now button 304 via user interface 302 while previewing en eBook. User interface 306 enables user 202 to enter payment information such as credit card information, PayPal account information, Google Checkout account information, or other suitable payment information. User interface 306 also enables user 202 to enter an email address if user 202 wishes to receive a receipt of the purchase by email.

FIG. 3C illustrates an example user interface 308 of a mobile application that provides user 202 with a confirmation of the purchase. In one example user interface 308 may be configured to provide user 202 with a smart tip button 310. For example, clicking on smart tip button 310 may provide user 202 with instructions on how to save the purchased eBook cover and title to a home screen of mobile device 100. It should be understood that smart tip button 310 may be configured to provide user 202 with other suitable information. It should be understood that user interfaces 302 and 306 may also be configured to provide a smart tip button 310.

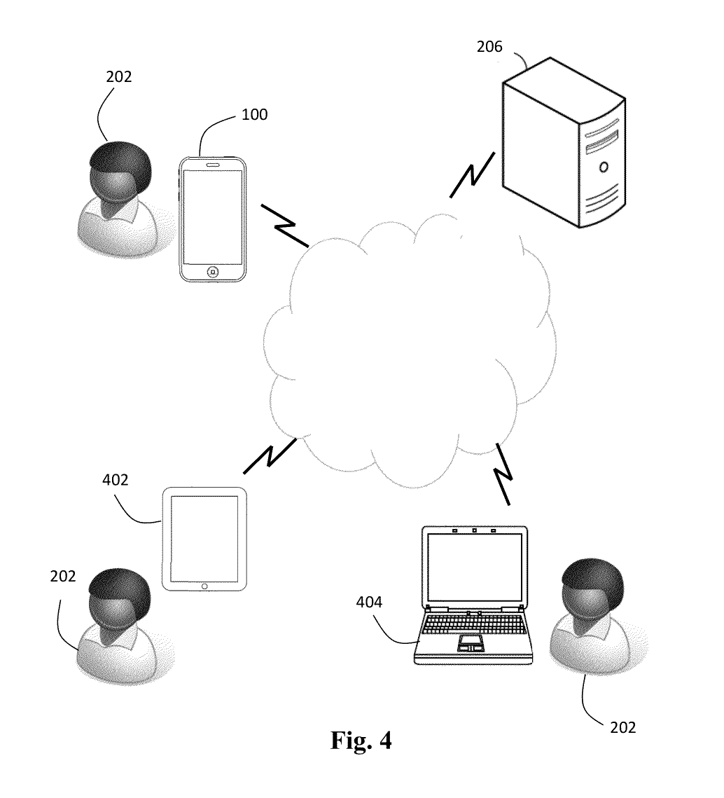

Referring again to FIG. 2, book server 206 is further configured to communicate to user 202 a passcode along with instructions for accessing a full version of an eBook in response to user 202 completing a purchase of the eBook. In one example, book server 206 communicates the passcode along with the instructions in the form of a text message to mobile device 100. In other examples, as illustrated in FIG. 4, book server 206 may communicate a passcode along with the instructions in the form of an email or other suitable form to user 202 via a tablet 402, a laptop computer 404, or other suitable computing device. Similarly, user 202 may access and read the purchased eBook using the passcode via mobile device 100, tablet 402, laptop computer 404, or via another suitable computing device.

As described, book server 206 may track purchase history associated with different users 202 based on phone numbers. In on example, book server 206 may be configured to provide an online bookshelf to identified users 202, based on a phone number, which stores and provides access to previously purchased eBooks. In other words, book server 206 may provide user 202 access to all previously purchased eBooks provided that user 202 interacts with book server 206 using the same mobile device having the same phone number.

In one example, user 202 may become a registered customer by providing account information such as name, passwords, mobile phone number and other suitable information. In one example, user 202 may become a registered customer by signing in using a social media account such as a Facebook account. By becoming a registered customer, user's 202 purchase history and online bookshelf may be tracked and provided to user 202 regardless of which device user 202 used to make the purchase or uses to interact with book server 206.

In one example, a user 202 may be provided with an option of sharing information about a purchase of an eBook or sharing an opinion of an eBook with a social network such as Facebook.

In one example, book server 206 may be configured to make book suggestions to user 202 based on user's 202 previous purchase history and past activity.

In one example, book server 206 may be configured to communicate to user 202 customized coupons or offers based on user's purchase history. For example, book server 206 may provide user 202 with a coupon for a discount on a next purchase of an eBook after a user purchases predefined number of eBooks. In another example, book server 206 may be configured to provide any user 202 browsing at a specific retail store at a specific time with a coupon or special offer. In one example, book server 206 may be configured to provide user 202 with an option to opt-in to receive a newsletter or to receive notifications about special offers

Book sever 206 is further configured to provide an administrator with an administrative portal for defining various settings and parameters for system 200. For example, the administrative portal may enable an administrator for define a keyword including a message associated with the keyword for a specific phone number and the digital media content associated with the keyword. An administrator can also define, for a specific phone number, what message is communicated to the user in response to receiving a specific keyword. An administrator may also define a date range for the availability of the message. For example, an administrator may define a start date and an end date, during which time the defined message will be communicated to a user in response to receiving the keyword. In other words, the defined message may have an expiration date. In one example, the defined message may not have an expiration date and instead have an end date of “never.”

The administrative portal may also enable an administrator to define phone numbers and associated information. For example, information associated with a defined phone number may include a “help” URL to provide a user with further instructions. Book server 206 is configured to communicate the help URL and a defined help message to mobile device 100 in response to receiving “help” or another suitable predefined text string or number.

Information associated with a defined phone number may also include a start message that is communicated to a mobile device 100 in response to receiving a keyword from the mobile device 100 for the first time. For example, Book server 206 may be configured to identify whether any communications have been previously received from a particular mobile device 100 by searching a database that stores message logs associated with individual mobile devices 100.

Information associated with a defined phone number may also include an opt out message that is communicated to a mobile device 100 in response to receiving “STOP” or another suitable predefined text string or number.

It should be appreciated that the administrative portal may be configured to enable an administrator to add, edit, or delete other suitable information in order to facilitate defining parameters for system 100.

The administrative portal may further enable an administrator to generate reports. For example, an administrator may be able to view statistics such as the number of incoming and outgoing texts for a selected time period. An administrator may also be able to view detailed information in a report such as the dates and times of the incoming and outgoing texts. It should be appreciated that the administrative portal may further enable an administrator to view other suitable information and to generate other suitable reports, based on the data collected by system 100.

It should be understood that the various capabilities described as being associated with book server 206 may be implemented using software, hardware, or a combination of both software and hardware. It should be further understood that, the various capabilities described as being associated with book server 206 may be implemented using a multiple servers located at the same or disparate locations.

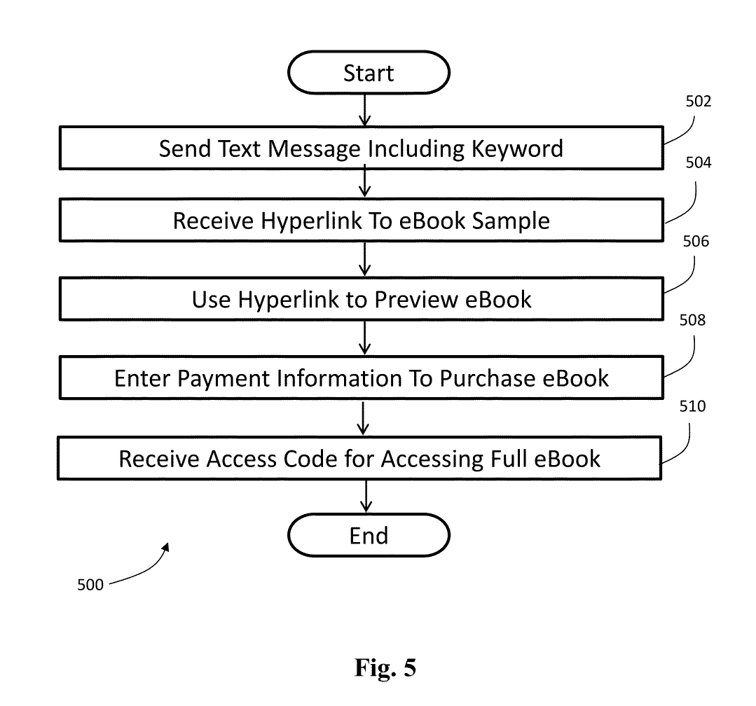

FIG. 5 is a flow chart illustrating the steps of an example method for sampling and purchasing an eBook. At step 502, a user sends a text message, including a keyword associated with a selected book title, using a mobile device. At step 504, the user receives a hyperlink for accessing a sample of the selected eBook. At step 506, the user clicks on the hyperlink to preview the eBook. At step 508, the user enters payment information to purchase a full version of the selected eBook. At step 510, the user receives an access code for accessing a full version of the selected eBook.

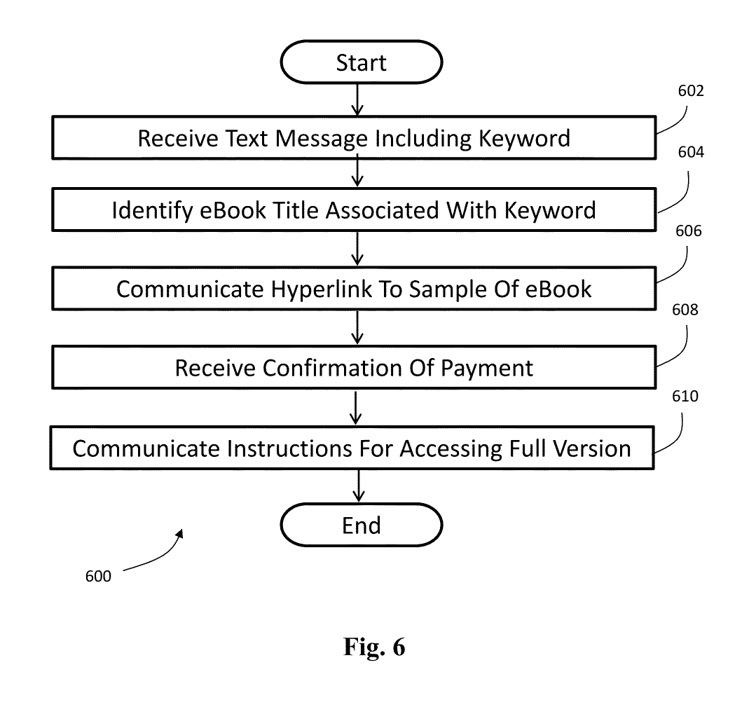

FIG. 6 is a flow chart illustrating the steps of an example method for sampling and purchasing an eBook. At step 602, a book server 206 receives a text message including a keyword from a user of a mobile device 100. At step 604, the book server 206 identifies an eBook, or other digital content, associated with the keyword. At step 606, the book server 206 communicates to the user of the mobile device 100 a hyperlink that directs the user to a sample of the identified eBook. At step 608, the book server 206 receives payment confirmation from the user of the mobile device 100. At step 610, the book server 206 communicates to the user of the mobile device 100 instructions for accessing a full version of the eBook.

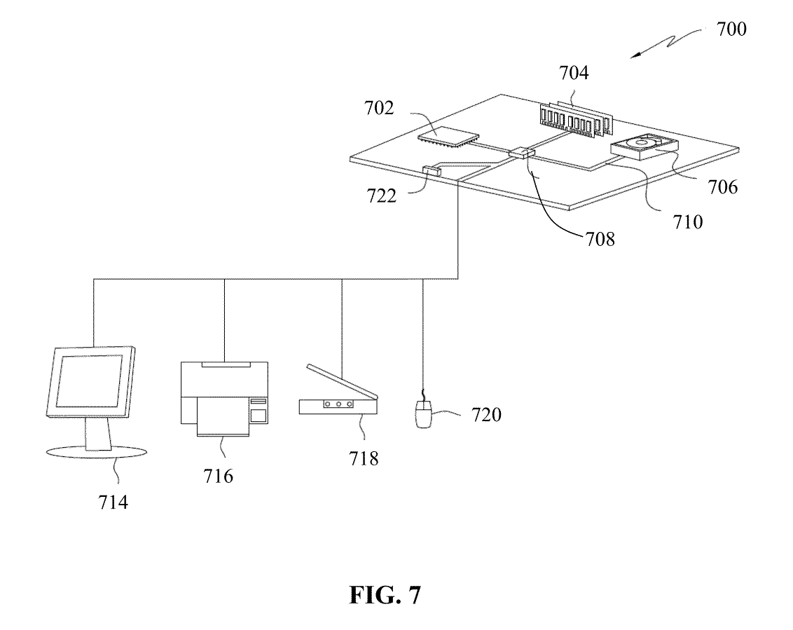

FIG. 7 is a block diagram of an example computing system 700 for implementing an example system for sampling and purchasing an eBook. The example computing system 700 is intended to represent various forms of digital computers, including laptops, desktops, handheld computers, smartphones, tablet computers, servers, and other similar types of computing devices. As shown, computing system 600 includes a processor 702, memory 704, a storage device 706, and a communication port 708, operably connected by an interface 710 via a bus 712.

Processor 702 processes instructions, via memory 704, for execution within computing system 700. In an example embodiment, multiple processors along with multiple memories may be used.

Memory 704 may be volatile memory or non-volatile memory. Memory 704 may be a computer-readable medium, such as a magnetic disk or optical disk. Storage device 706 may be a computer-readable medium, such as floppy disk devices, a hard disk device, optical disk device, a tape device, a flash memory, phase change memory, or other similar solid state memory device, or an array of devices, including devices in a storage area network of other configurations. A computer program product can be tangibly embodied in a computer readable medium such as memory 704 or storage device 706.

Computing system 700 may be coupled to one or more input and output devices such as a display 714, a printer 716, a scanner 718, and a mouse 720.

While example systems, methods, and so on, have been illustrated by describing examples, and while the examples have been described in considerable detail, it is not the intention to restrict or in any way limit the scope of the appended claims to such detail. It is simply not possible to describe every conceivable combination of components or methodologies for purposes of describing the systems, methods, and so on. With the benefit of this application, additional advantages and modifications will readily appear to those skilled in the art. The scope of the invention is to be determined by the appended claims and their equivalents.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

What is claimed is:

1. A system for sampling and purchasing digital content comprising:
at least one processor;
at least one computer-readable tangible storage device; and
program instructions stored on the at least one computer-readable tangible storage device for execution by the at least one processor, the program instructions comprising:
first program instructions configured to receive data indicative of a keyword;
second program instructions configured to identify digital media content associated with the keyword;
third program instructions configured to communicate data indicative of a hyperlink, wherein the hyperlink is configured to link to a sample content associated with the digital media content;
fourth program instructions configured to receive payment confirmation; and
fifth program instructions configured to communicate data indicative of instructions for accessing the digital media content.

2. The system of claim 1, wherein at least one of the data indicative of a keyword and the data indicative of a hyperlink comprises an SMS message.

3. The system of claim 1, wherein the digital media content comprises an eBook.

4. The system of claim 1, wherein the program instructions further comprise sixth program instructions configured to generate the hyperlink so that the hyperlink comprises data indicative of at least one of a computing device or a store.

5. The system of claim 1, wherein the program instructions further comprise sixth program instructions configured to generate the sample content, customized for a user, based on a user preference.

6. The system of claim 1, wherein the fifth program instructions are further configured to communicate an SMS message comprising a passcode.

7. The system of claim 1, wherein the program instructions further comprise:
sixth program instructions configured to track previously purchased digital media content; and
seventh program instructions configured to provide access to the previously purchased digital media content.

8. A method for sampling and purchasing digital content, the method comprising the steps of:
a computer receiving from a mobile computing device data indicative of a keyword;
the computer identifying digital media content associated with the keyword;
the computer communicating to the mobile computing device data indicative of a hyperlink, wherein the hyperlink is configured to link to sample content associated with the digital media content;
the computer receiving payment confirmation from the mobile computing device; and
the computer communicating to the mobile computing device data indicative of instructions for accessing the digital media content.

9. The method of claim 8, wherein at least one of the data indicative of a keyword and the data indicative of a hyperlink comprises an SMS message.

10. The method of claim 8, wherein the digital media content comprises an eBook.

11. The method of claim 8, further comprising the step of generating the hyperlink, wherein the hyperlink is customized and comprises data indicative of at least one of the mobile computing device or a store.

12. The method of claim 8, further comprising the step of generating the sample content, customized for a user, based on a user preference.

13. The method of claim 8, wherein the step of the computer communicating the data indicative of instructions for accessing the digital media content comprises the computer communicating an SMS message comprising a passcode.

14. The method of claim 8, further comprising the steps of:
the computer tracking previously purchased media content; and
the computer providing access to the previously purchased digital media content.

15. A computer program product for sampling and purchasing digital content, the computer program product comprising:
at least one computer-readable tangible storage device; and
program instructions stored on the at least one storage device, the program instructions comprising:
first program instructions configured to receive data indicative of a keyword;
second program instructions configured to identify digital media content associated with the keyword;
third program instructions configured to communicate data indicative of a hyperlink, wherein the hyperlink is configured to link to sample content associated with the digital media content;
fourth program instructions configured to receive payment confirmation; and
fifth program instructions configured to communicate data indicative of instructions for accessing the digital media content.

16. The computer program product of claim 15, wherein at least one of the data indicative of a keyword and the data indicative of a hyperlink comprises an SMS message.

17. The computer program product of claim 15, wherein the digital media content comprises an eBook.

18. The computer program product of claim 15, wherein the program instructions further comprise sixth program instructions configured to generate the hyperlink, wherein the hyperlink is customized and comprises data indicative of at least one of a computing device or a store.

19. The computer program product of claim 15, wherein the program instructions further comprise sixth program instructions configured to generate the sample content, customized for a user, based on a user preference.

20. The computer program product of claim 15, wherein the fifth program instructions are further configured to communicate an SMS message comprising a passcode.
